(19) United States
(12) Patent Application Publication
(10) Pub. No.: US 2009/0037310 A1
(43) Pub. Date: Feb. 5, 2009

(54) Account With Easily Interchangeable Features

(75) Inventors: Richard J. Claypoole, Hoover, AL (US); William T. Hippensteel, Birmingham, AL (US); Mark Gibson, Birmingham, AL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Compass Bancshares Inc., Birmingham, AL (US)

(21) Appl. No.: 12/182,891

(22) Filed: Jul. 30, 2008

Related U.S. Application Data
(60) Provisional application No. 60/952,791, filed on Jul. 30, 2007.

(51) Int. Cl. G06Q 40/00

(52) U.S. Cl. 705/35

(57) ABSTRACT

An account, such as a checking account or other instrument, is provided having a number of interchangeable features. The customer is given a choice of a number of available features such that a tailored account is created. Further, in a preferred embodiment the features are divided into standard and premium features of which the customer can choose a select number of each upon opening the account. The customer can thereafter change and interchange the features as needed, at no cost, and in real time as often as desired, such that as the customer's life or conditions change the account is always tailor-fit to the customer's needs. Further, additional features can be added to the account at an additional cost to the customer. Changes in features can be made with no need to close an account and then open a substitute account and at no cost to the customer.

### RELATED APPLICATION

This application is related to U.S. Provisional Patent Application No. 60/952,791, entitled Customizable Checking, and is incorporated in full in this application as if set forth in its entirety herein.

### FIELD OF THE INVENTION

The present invention concerns a banking instrument wherein the user can select from a number of allowable features and change those features as desired. More particularly the present invention concerns a customizable checking account allowing a customer to choose features pertinent to the manner in which they bank and then change the features for convenience as conditions change.

### BACKGROUND OF THE INVENTION

Banks and other savings institutions offer many variations of different accounts. Typically the variations begin with standard instruments such as checking accounts, savings accounts and some form of money market accounts; concomitantly, other instruments such as certificates of deposits, safety deposit boxes and ATM machines are available. Typically, with respect to checking and savings instruments the features that are available to each instrument are fixed at the time of the opening of such an account.

For example, a checking account may include no-charge checks if the user either keeps a minimum balance in the account or provides funds through a direct deposit program. In another example, a minimum balance in a particular account will allow the user to have no-cost checks and a modicum of interest paid on the balance in the account. Typically all such accounts are provided with automatic teller machine (ATM) access either through a regular ATM card or through some no-fee major credit company debit-style card. It is generally the case that the greater the balance kept in a banking instrument the more features are provided to that account, however, typically all such features are set in advance (at the time of opening the instrument) and cannot be altered or interchanged.

As a result when a customer's banking needs change, the usual course of business is to open a new account for the customer. This causes difficulties and inconvenience for both the customer and the bank or savings institution. For example, a long-term checking account holder may need to open a new account due to a change in status, wherein the required balance of his previous account is too high for him to maintain. Such a change would force the customer to open a new account (with different account numbers) which would make all previous electronic payment instructions inaccurate. The customer would have to contact all different creditors that automatically debit the account to change the account numbers and all sources of direct deposits would also have to be contacted. Often times one or more of these are forgotten until a notice of overdue payment is received and fees and interest have been charged. Further, matters as simple as check numbers could be affected causing confusion in bookkeeping for the customer, or causing embarrassment that the customer's checks have low numbers and therefore may not be accepted by certain creditors.

Changes to banking services have also been inconvenient to achieve as they typically require a trip to the branch office of the bank along with the filling out of forms requiring detailed information and verification when new accounts are opened. Delays in opening accounts, due to the coming of a weekend, the end of the banking hour and verification difficulties can cause considerable delays in banking changes that may be needed immediately.

### SUMMARY OF THE INVENTION

In accordance with the present invention, a customizable banking account has been developed that permits the user to modify the various features of his account quickly and achieve a banking instrument tailored to his needs even as his needs fluctuate.

An account for the management of money having easily interchangeable features is provided using computer program functions, having means to receive and process banking information and change account information and features as directed. The account includes access through a number of platforms, including bank branches, call centers and Internet access via personal computer. The account is furnished with a list of desirable banking instruments from which a customer may choose a select number, wherein, the account is then opened with selected features and then, when desired, changed by the removal of certain features and the addition of others.

The account includes a first set of standard features and a second set of premium features and initially the customer can have all of the first set of standard features and at least two features from the second set of premium features at no cost to the customer. As desired or needed by the customer, the premium features first selected can be exchanged for those not selected, all in real time via computer access at any of the provided platforms. The changes to the account are immediate and available upon the changes being finalized.

The invention further includes a method of managing assets in a bank environment by providing a number of interchangeable account features. The method includes the steps of providing a customer with a choice of a number of first banking or financial features and providing the customer with a choice of a number of second banking or financial features. The first banking features are standard features and the second banking features are premium features, both noted below. The method includes allowing the customer to initially select several of the first banking or financial features and second banking or financial features as part of the account and then allowing for the selection of further features from either the first or second banking or financial features either as replacements for the initially selected features or at a cost as additional features. The account and its features can be monitored and manipulated in real time via a computer running software associated therewith.

It will be understood that the language of banking and computer science are used in this application in a manner that will be understood by persons having ordinary skill in the art; various banking features and instruments are mentioned by their common well known names, and it will be understood that these features should be given their common meanings or meanings that will allow for the understanding of the invention by persons having ordinary skill in the art.

In one embodiment of the present invention, an account such as a Build-to-Order Checking® (BTO) checking account of Compass Bancshares, Inc. of Birmingham, Ala., is developed wherein the basic account is provided free to bank customers and has features that are found in accounts having either minimum deposit requirements, direct deposit requirements or fee schedules or any variation thereof. The BTO account of the present embodiment provides for free checking, that is with a deposit of funds the user of the account is allowed to access the funds via checks that are drawn on the account. In the present embodiment, the account is provided with a number of standard features that come at no cost to the account holder and a set number of additional desirable features, from a list of such features, from which the account holder can choose at no additional cost. Additionally, all of the features are available to each account holder for an additional cost. Therefore, in the present example the account has two distinct categories of features—those that are included in the account basic package and those from which the holder can choose to include at no additional cost. In a preferred embodiment of the present invention, the account has 10 basic features provided at no cost and 7 additional features of which the account holder may choose two at no additional cost and the remainder for a fee per feature. In other embodiments all 17 (or more) features can all be combined as a single set and the customer can choose 12 total features (or as many features as allowable per account) as desired; changing amongst them as needed.

In one embodiment the basic features can include the following 1) a no minimum balance requirement bank account, 2) a no-cost check card for access to cash or to make purchases, 3) no-cost access to online banking features, 4) no-cost bill payment features 5) a free Visa® Extras program 6) $2,500 ID theft insurance, 7) one free order of checks, 8) no-fee access to the account bank's automatic teller machines (ATM), 9) no requirement of direct-deposits to the account and 10) free e-mail alerts of important account information, such as overdrafts or insufficient funds.

In a preferred account, for example, the holder is given the following features in addition to the usual features of check writing, free first order of checks, no minimum balance requirement and access via ATM as well as other features found in a better checking account: 1) a free debit card based reward card, such as a Visa® Check Card having rewards capabilities; 2) free on-line banking and bill paying access; 3) free e-mail alerts that the user can set-up so as to give warnings of impending overdrafts, as well as alerts for online accounts, balances, tracking, credit card, airline miles and other bank, bank card and account related information; and 4) a specified amount of identity theft insurance, in a preferred embodiment $2,500 worth. These four features, when added to the features provided as standard on a better checking account can amount to equivalence with the ten features noted above. In a preferred embodiment the account further can include access to an associated savings account.

In addition to the features given as a basic package in the account of the preferred embodiment, the holder may also be able to choose a set number of more premium features. In the preferred embodiment the following features are offered to the account holder; it will be understood that the following list is not exhaustive and that other features, including financial related features, brokerage features, mortgage features, other banking features, household, tax, other planning (including estate, retirement, health maintenance, insurance) and others in financial, management and other aspects of services and goods, can be included without departing from the novel scope of the present invention. In the preferred embodiment, the additional features include: 1) no fee ATM usage of other institutions' ATMs; 2) rebates of other institutions' fees for use of ATMs or other bank services; 3) interest earnings on account balance; 4) extended rewards on major check card instruments (such as double Visa® rewards); 5) cash back rewards on check card purchases; 6) a cash reward earned on the anniversary of the opening of the account; and 7) limited overdraft fee forgiveness. Each of these will be discussed in greater detail below. It will be understood that the entire number of features can be presented as a single package allowing the customer to choose from the seventeen features a specific number and interchange those features as needed or desired. The changes to the features, as will be described below, can be made quickly by the customer and can be changed again as quickly with no penalty. During banking hours, as quickly as one feature can be added it can subsequently be removed and changed for a different feature.

In a preferred embodiment of the account of the present invention, an individual can decide to open the account and then do so using various means, including going to a branch office of the institution, applying by mail, applying via telephone or applying via the Internet. Each access point is designed to provide information on the various features and numbers of features available to the account holder and the manner in which features can be changed, how to change the features and the effective time of the change instantly to the user. In this manner the user not only has an account that can be modified instantly to fit changing needs, but also has ready information as to the effect and efficacy of the changes.

In opening the account of the present embodiment, the customer is encouraged to decide which of the additional features will permit the most savings to the customer.

A more detailed explanation of the invention is provided in the following description and claims and is illustrated in the accompanying drawings.

### BRIEF DESCRIPTION OF THE DRAWINGS

FIG. 1 is a schematic representation of the method of developing the account of the present invention.

FIG. 2 is a schematic representation of the method of opening an account of the present invention.

FIG. 3 is a schematic representation of the manner of displaying the account selections made in accordance with FIG. 2.

FIG. 4 is a schematic representation of the method of adding additional features to an account of the present invention.

FIG. 5 is a schematic representation of changing optional parameters of an account of the present invention.

FIG. 6 is a schematic representation of the method of requesting the history of chosen account options of an account of the present invention.

An Appendix comprising the following documents is attached:
Customizable Checking ETL Function requirements; CCDB Database Functional Design Document; and Customizable Checking Planning Definition Document.
   The Appendix is incorporated as if set forth in full herein.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

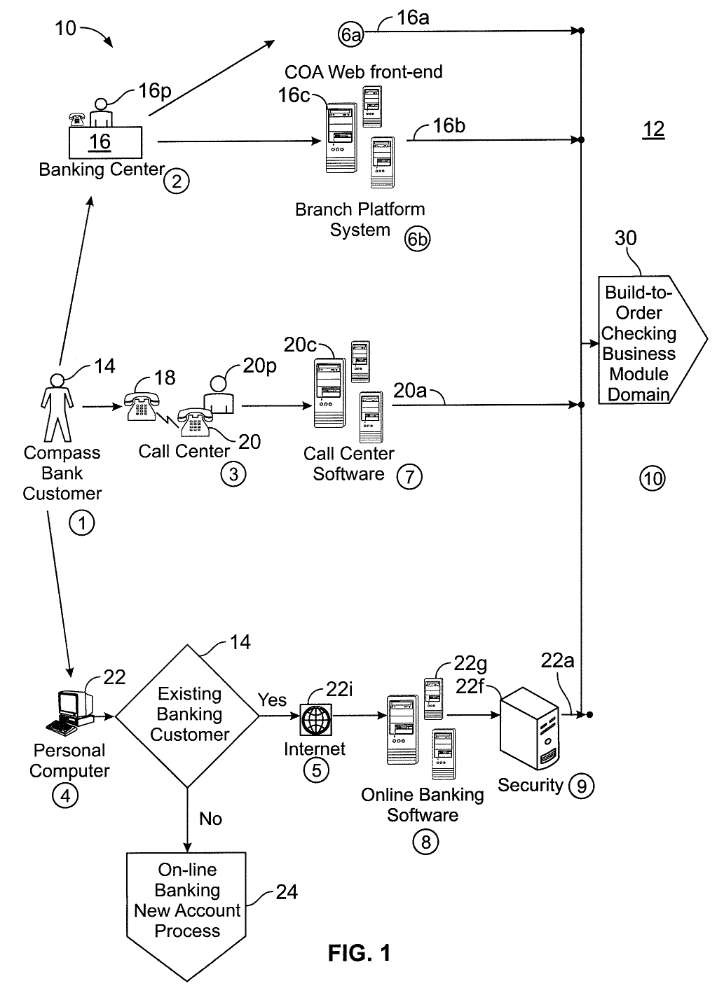

Reference is now made to the drawing figures of the present invention, which while illustrating steps in the method of the present invention and the actual device of the present invention further, are also representative of the underlying computer program used to develop, manage and run the method and device of the present invention. FIG. 1 shows a schematic representation of the gateway 10 to entry into the account 12 of the present invention. The set-up of FIG. 1 is used in various stages of the account of the present invention, including the initial opening of the account and management of the account through various stages in the life of the account and the life of the account holder. Common to all aspects is the customer 14 who can access the account 12 through various means, including, but not limited to direct physical contact with a banking center 16, via telephone 18 to a call center 20 or via computer 22 via the Internet 22i or other computer connectivity systems. It will be understood by persons having ordinary skill in the art that the list of means to access the account listed here are meant as illustrative and are not meant as limiting. Each method of access, and most specifically the computer access method, will be described in greater detail below. While in most of the illustrative embodiments the account noted is described as a banking account, it will be understood that the term banking is used for its most general meaning and that many types of accounts or financial instruments can be made to have similar features, including accounts at savings and loan institutions, brokerage houses and others, without departing from the novel scope of the present invention.

As shown in FIG. 1, banking center 16 is typically manned by account professionals or banking professional 16p and other banking personnel and is directly connected to a computer system 16c, which in the illustrative example is shown as a Customizable Option Application (COA) Web Front-end system, of a type known to persons having ordinary skill in the art. While the COA Web Front-end system is shown in the diagram and described herein, it will be understood that other computer architectures can be used to open and manage the account of the present invention without departing from the novel scope of the present invention. In a preferred embodiment an account professional 16p is provided both with an internal Web system, such as an in-house designed and built front-end system for direct updates to the COA 16a, and/or in-house software 16b as methods for the account professional 16p to directly access the in-house computer system to open an account. In one example, the in-house computer system 16b, for example at Compass Bank (Compass Bancshares, Inc. of Birmingham, Ala.), uses vendor software in-house, from S1 Corporation of Norcross, Ga., named Navigator; which in the

case of Compass Bank includes any software that allows banking personnel to open new accounts.

Referring to FIG. 1, routes 16a and 16b take the banking center professional 16p into the Build-To-Order (BTO) business module domain 30 where the opening and the management

of the account of the present invention occurs and which will be discussed in greater detail below.

With respect to call center 20, it will be understood that call center personnel 20p are also banking professionals of the type in the physical banking center 16. While a call center 20 can be in a separate location manned by distinct personnel, trained to operate the call center and open accounts of the type presented in the present invention, they can also be, as will be understood by persons having ordinary skill in the art, banking professionals 16p at a banking center 16, without departing from the novel scope of the present invention.

Call center personnel 20p will be provided access to a computer system and software 20c capable of responding to the needs of the call center personnel 20p to provide account information and to open accounts of the present invention. In the example of Compass Bank noted hereafter, the call centers of Compass Bank employ vendor software in-house from Seibel Corp. However, it will be understood that any software that allows a telephone representative access to view and update customer records and to open and service accounts can be used instead without departing from the novel scope of the present invention. The call center system and software 20c are a further route to the BTO checking business module domain 30.

The operation of the call center and branch office will allow a user to either call in or go to the bank to open their account, and as will be described in greater detail below, seek advice with respect to the features of the account of the present invention and allow personnel 16p and 20p to access the BTO domain 30 to open an account and/or change the features of an open account as desired.

FIG. 1 shows, further, a third manner of opening and managing an account of the present invention. In the third manner, the bank customer, or prospective customer, can use his own personal computer 22 (or a public terminal if desired) via the Internet 22i to both open and manage his account as needed or desired. Through an Internet 22i gateway, the customer is given access to on-line banking software 22s that in turn has access to the BTO domain 30. It will be understood that access through a personal computer 22 presents numerous security issues that are well known to persons having skill in the art and which are anathema to the operation of

a banking institution. As a result, in a preferred embodiment, security systems 22f are incorporated between the external Internet 22i access and the BTO domain 30.

The software and computer systems noted and of the type that will accomplish the goals of the present invention are incorporated herein by reference.

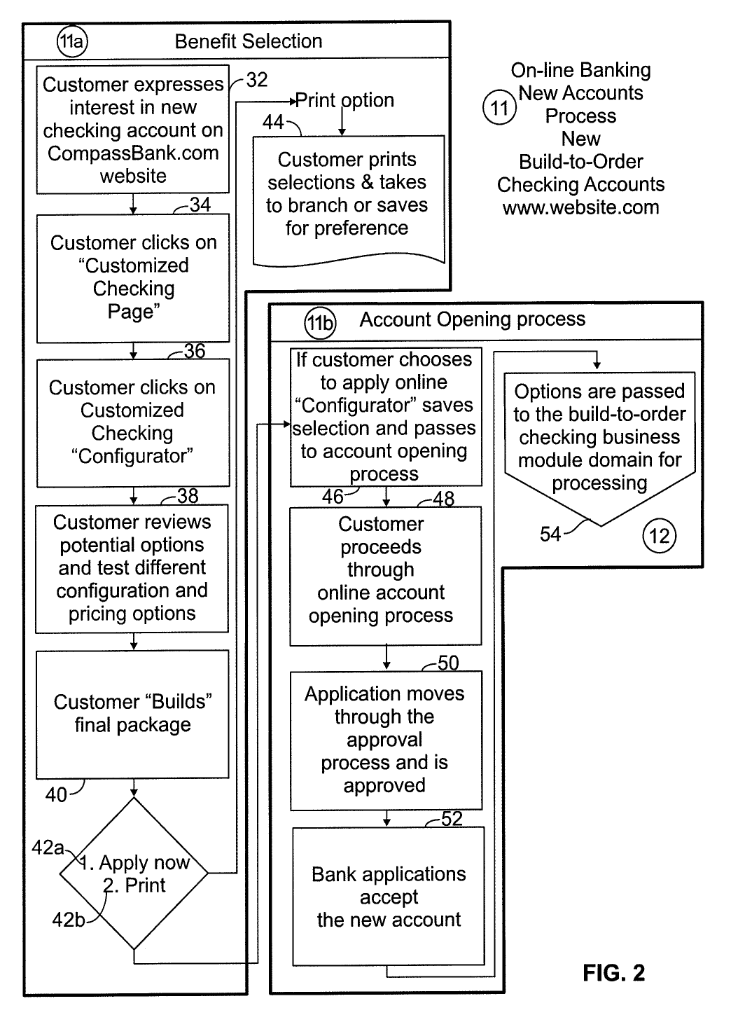

Referring again to FIG. 1, it will be seen that the schematic includes a more detailed explanation of the on-line banking/new account process 24, which will be discussed in detail in association with the discussion of FIG. 2.

Referring now to FIG. 2, a preferred procedure for opening an account and then selecting the desired account options via Internet access 22i is shown in a flow diagram. In the operation the prospective customer 14 is directed to an Internet web site from either an advertisement, notice from an institution or word of mouth and proceeds to the Internet web site of the account generator. To proceed with the embodiment that has previously been followed, the user after expressing interest 32 in an account 12 would go to the web address of Compass Bank, which typically contains World Wide Web (“www.”) access coding as well as the domain level indicator (such as “.com”) and the institutions domain name (such as “compassbank”). Within that website the customer 14 would then find and select the hyperlink 36 designated for the account (in the illustrative embodiment the hyperlink would be labeled “Custom Check Configurator”) which would take the customer to the appropriate website page. In the preferred embodiment Configurator 38, from Compassbank.com, is a sales and marketing tool that allows the Compass Bank customer to read the description of each option and make a decision on which options are best for them.

At Configurator 38, the customer would then review the options available and can test different configurations for the account and the costs thereof. When all of the decisions are made, the customer selects to build the account desired (40) and, in the preferred embodiment can choose to open the account (42a) or to print the parameters of the account to paper (42b) so that the document can be taken (44) to a branch bank location 16 (FIG. 1) and allow a banking professional 16p to open the account.

If the customer 14 chooses to open the account (42a) on-line, that selection then takes the user, through the website, to an information upload and save location (46) which passes the saved information to the on-line account opening process (48). The application is entered into the opening process and forwarded for approval (50). If after review the bank accepts (52) the account 12, the options selected in steps 38 and 40 are passed onto the BTO Business Model Domain (56) for processing and subsequent opening of the account.

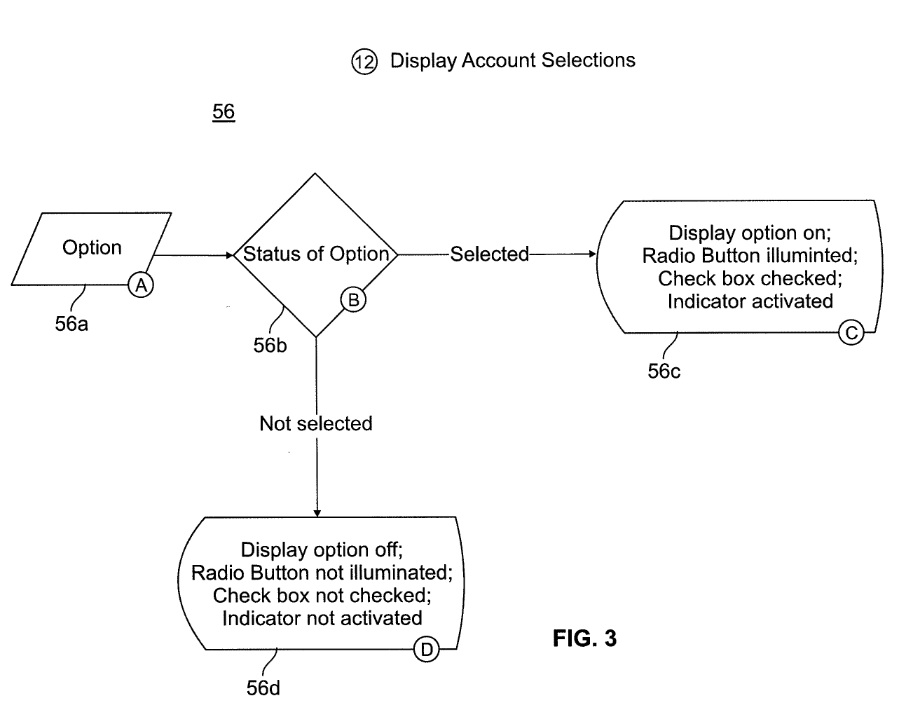

FIG. 3 illustrates the steps of processing (56) the options selected in steps 38 and 40 of FIG. 2 when opening the account. In the process, each available option is checked (56a), such that its status (56b), that is whether it has been selected or not, is determined. If the option is selected (56c) the system illuminates a radio button and a check box is activated to indicate that the option is activated; if not selected (56d) the radio button is not illuminated and the check box is not checked. The process is repeated for all the available options until they have all both been illuminated and checked or not.

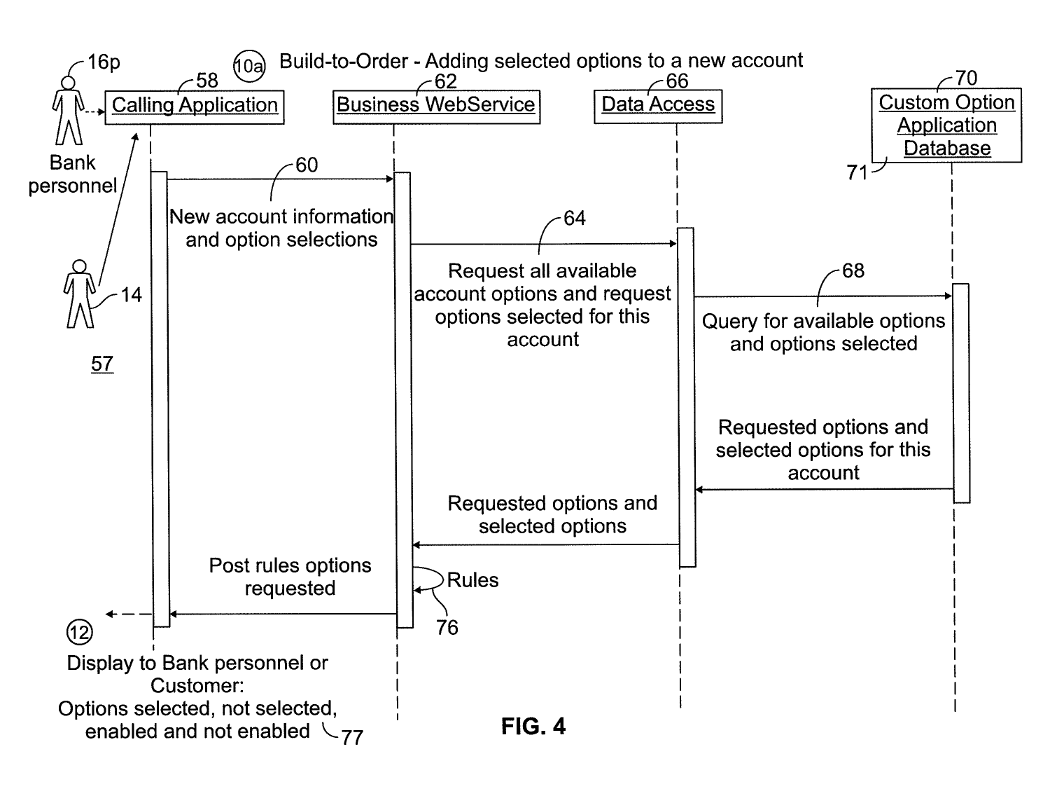

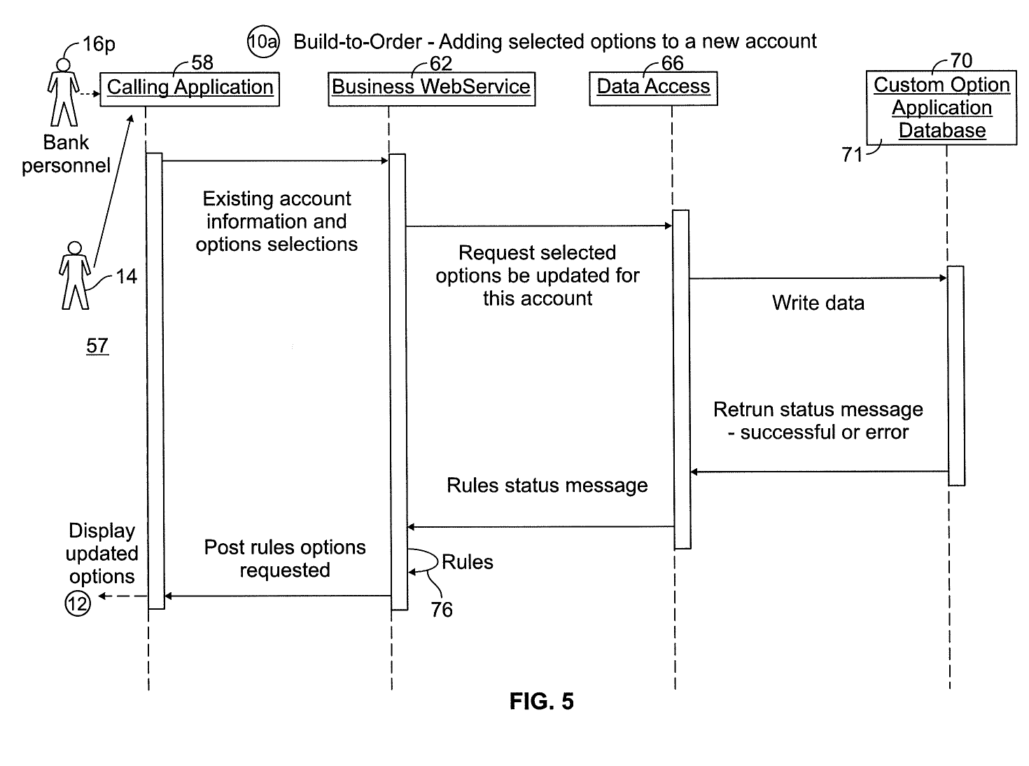

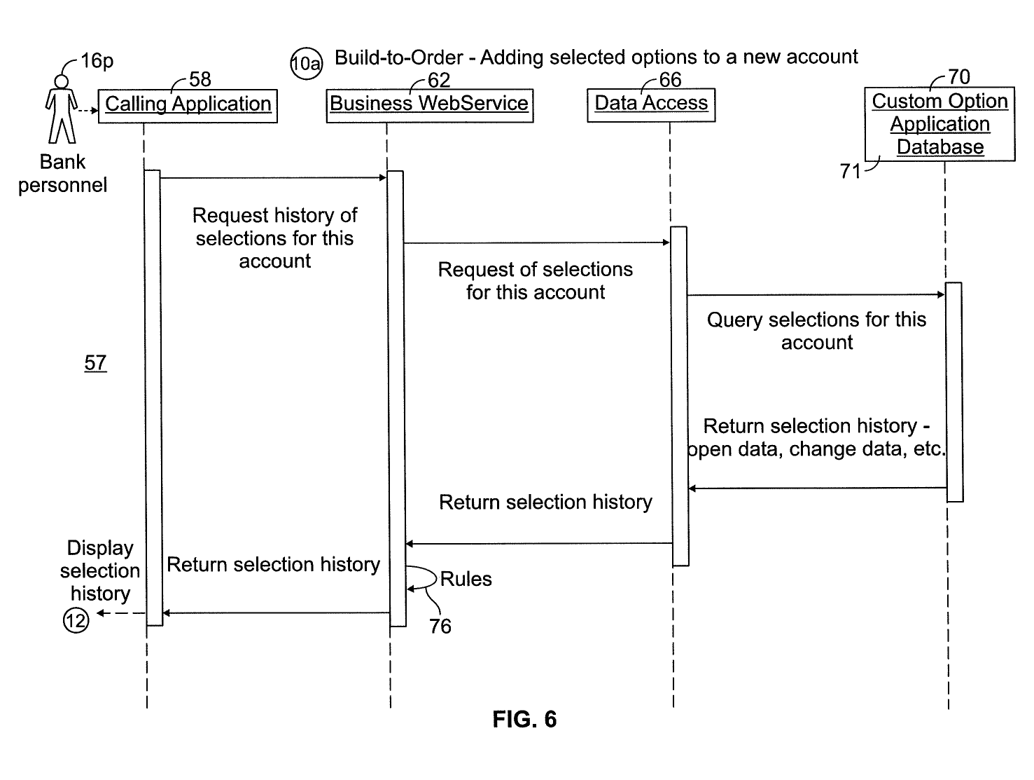

Referring now to FIGS. 4, 5 and 6, more specific details of the Build to Order (BTO) module are described. FIG. 4 shows the steps in adding selected options to a new account, FIG. 5 shows the steps for changing options in existing accounts and FIG. 6 shows the steps of requesting a history of options for an account.

FIG. 4 is a schematic depiction of the steps to be taken when adding selected options to a new account of the present invention. In FIG. 4, a banking professional 16p, or a bank customer 14, uses an application 58 on his computer (either at the bank with respect to the bank professional or via the Internet with respect to the bank customer) to call up the new account screen so as to enter the new account information (such as name of customer, address, social security number, amount of deposit and other information) as well as to enter the options (60) for the account entered by the customer. The computer accesses the bank's business web service 62 for data entry; the banking professional 16p or customer 14 requests (64) all available account options and specifically all options available to the specific account data from the computer's data access center 66. The query of available options (68) is referred to the Custom Option Application (COA) database 70. The COA 70 returns data concerning the requested options and selected options 72 to the data access center 66 and the business web service 62, where the options are checked against the rules (76) for the specific option that are posted, the results after checking are provided at the calling-application-terminal 58 for display to the banking professional 16p or customer 14. The display can include the options selected, not selected, enabled and/or disabled 77. This computer system, or Build-to-Order Business Module Domain 57, comprises all of the system parts associated with storing, adding, changing, deleting, and reporting the options the customer may select. This process communicates with backend, back office applications such as checking account and savings account information files to give the entire information concerning the account and the customer to the banking professional as well as clears the options through data processing and rules construction.

The COA 70 comprises data and systems directed to the business workflow, which contains the rules for each option. For example, with respect to the $25 Account Anniversary Bonus option (noted above), the rule notes that if selected it can be paid to a customer who has had at least one transaction per statement cycle for the last 12 months and selected this option at the beginning of that 12 month cycle. Rules exist for each option and can be changed, in real time to reflect a change of the option or to reflect a real life need for the change, for example, due to banking regulations or for competitive needs. In addition, as seen in FIG. 6, the COA 70 contains the Custom Options Database (CCDB) 71, which maintains the options and history of options for each Build-to-Order Checking account.

Referring to FIGS. 5 and 6, similar query and response schematics are shown for changes made to existing accounts and requests for history of options for an account, respectively; with corresponding changes in query structure to fit the situation of each respective query.

An understanding of the use of the account of the present invention may be assisted by reviewing some examples of how such an account can be opened, used, modified and then used in its modified form:

### Example 1

A young person, entering college, decides that a checking account is needed to manage funds and pay accounts in his new emancipated state, away from his parent's home. This new customer comes to a branch office of a bank offering this account, for example a branch office of Compass Bank, a Compass Bancshares, Inc. bank, who can assist the new customer to open a checking account. It will be understood that in the present invention the customer may open an account at a bank facility, over the telephone to a banking center and through Internet access to a bank web site; however, the manner in which this account is opened for the present example, is shown for illustrative purposes only. The new customer selects an account of the present invention and thereby is given the following features at no cost to the customer: a free VISA® check card with free VISA® extras; free online banking and bill pay; free email alerts to designated account conditions; and $2,500 identity theft insurance with fraud assistance. The features are provided for opening the account and include the usual checking features found in a checking account. In one embodiment of such an account, a minimum opening deposit of $25 would be needed to open the account but then no minimum balance or direct deposit requirement would be required to maintain the account open. In one embodiment an additional free savings account is given at the time of the opening of the checking account. It will be understood that minimum deposits and requirements for no direct deposit are hypothetical features and that the present disclosure of these features, or any features, are not ascribable to any bank or banking institution and are only included herein as hypothetical features that can be added to a basic bank account.

The user, having been given the above features for the new bank account is then offered, from a list of seven additional premium features, the choice of two for no additional cost. The seven features offered include: no fee usage of third party ATMs; rebate of fees charged by third parties to use ATMs; interest on checking account balance; double VISA® rewards points; cash back rewards on check card purchases; a $25 annual gift for remaining a customer of the bank; and one overdraft forgiveness refund per year. As the new customer is new to the account and using a checking account as well as the fact that he is entering college and may be moving to a location where the bank has no branch, he will likely select those features that will allow him to save fees. For example, he may select the no fee usage of third party ATMs as well as the rebate of ATM fees as considering that there is no local branch at school and that he will be using his ATM card to retrieve cash for expenses, the fees generated thereby may be prohibitively expensive. Often times a third party ATM will charge two or three dollars to handle a transaction, including retrieving cash therefrom. If the customer retrieves cash once per week they may be paying eight to twelve dollars per month in ATM fees; in one year's time those fees will amount to about $96.00 to $144.00 per year. A review of the other features offered by the bank would show that no other feature returns such an advantage for this particular customer. Further, the choice of the no fee to use a third party ATM would save the customer its bank's fees for such usage.

When this customer arrives at college he finds that there is an ATM machine on campus that does not charge third party fees. At this point, the customer determines that this particular feature of the account is not providing value to him, as he need pay no fees to another bank to use the ATM. The new customer can then either call a bank center or reach the bank via the Internet to change the features of his account. It will be understood that the customer can also go to any branch office of the bank to change this feature as well; however, as noted above, at the customer's college location there is no branch for the bank that he chose to open his account. Upon calling or making an Internet connection, the customer then chooses to drop the rebate of fees feature and selects instead to choose the one overdraft fee forgiveness per year feature. It is not atypical of those new to checking accounts to have an overdraft in their first year of using a checking account. As will be understood by persons having ordinary skill in the art, a checking account requires the discipline to know or determine the funds on deposit and available and the writing of checks or using of an ATM card responsibly so as not to exceed the amount available. New users have been known to overdraw and therefore, having seen his friends charged large fees for overdrawing their accounts, and receiving notices from creditors of returned checks with non-sufficient funds (NSF) the new customer decides to protect his account in this manner.

In one embodiment of the invention of the present invention the change in account is effective when made as long as it is made during banking hours, which hours will be announced to the customer either at the bank branch, over the telephone or on-line at the interactive web site. If the changes are made after banking hours, the change is effective as of the beginning of banking hours on the next business day, if made at any time during banking hours the change is effective as if it had been made at the beginning of banking hours that day.

The change in banking features when completed is effective until changed again for most features. The new customer can continue to manipulate the parameters of his account so that he achieves the account most closely fitting his needs. As the needs of the customer change, so to can the parameters of the account.

### Example 2

A college graduate, holder of an account of the present invention, secures a job in a new city and begins the process of transitioning from student to professional. The account as presently held has all of the standard features as well as overdraft protection and no-fee usage of third party ATMs. As the customer is moving to the professional world, with a steady paycheck, and has been using a checking account for well over four years now, overdraft protection is no longer a grave concern. Some of the other features of the account may now prove to be beneficial. The customer will need to buy business clothing and equip a house or apartment with the needs of a worker.

The customer calls a telephone banking center, and with the counseling of the banker on the telephone, determines that a cash back reward on his check card purchases would prove a better choice at this stage in his life than overdraft protection. With the number of purchases the customer will be making as he enters the work world, cash back on these purchases will fit his budget best, providing a return on all of his spending. In one embodiment of the present invention, the cash back rewards is $0.05 on every qualified purchase made with the check card and $0.05 made on every two PIN-based purchases.

Further, as the customer is returning to an area where his bank maintains ATMs he will no longer need to have the feature allowing for no-fee use of third party ATMs nor will he need to have rebates of ATM fees. The customer cancels this feature and chooses to have the double VISA® rewards points. As his spending is increasing, until he equips his new home and purchases what he needs for the work world, he decides now is the time to have double points; which he can later translate into travel or entertainment options. He requests this change via his Internet connection to the bank, as he had forgotten to make this change when he spoke to the bank telephone center operator. The change is effective the next morning during banking hours.

### Example 3

Having worked now for several weeks and chosen direct deposit at work, the customer now realizes that his big purchases are done for the time being and that he should change his account to now better fit the way he is banking. He calls his banker and asks to drop the cash back awards on his check card purchases as the amount he is currently earning is less than he would earn if he had interest on the amount of money he has in his account. He therefore asks that the cash back feature be dropped and adds the Interest on Balance feature. He maintains the double reward feature as he is using his VISA® card more often in the working world and the points are accumulating.

### Example 4

The customer is now established, having worked for many years and is no longer making many VISA® purchases, or has decided that the rewards offered are no longer needed. He accesses his account and changes the “rewards” feature to the $25 cash payment on the anniversary of his account feature. In this feature he will receive a payment of $25 to his account, at the end of each anniversary of the opening of his account, when he has had the feature activated for at least an entire one-year period. In this example, the customer changes to this feature on the eve of the anniversary of opening the account and will, therefore, receive a $25 payment next year on the anniversary of his account, if he keeps this feature active for the one-year period.

### Example 5

The customer arranges for a trip either on business or for pleasure, and calls the telephone center of the bank to have his account changed so that while he is away he is able to secure cash through the ATMs of third party banks or financial institutions and have those fees reversed. Rather than change any of the options that the customer presently has he decides to add the feature, at a minimal cost. He therefore, for this time can continue his double Visa® rewards as well as maintain his $25 annual reward and now can access third party ATMs for a small one-time fee rather than a per transaction charge. Upon returning home the customer cancels the feature. In one preferred embodiment of this example, the customer, prior to boarding his flight changes the option via his personal digital assistant (PDA) such as his Blackberry device, his laptop computer via the Internet or via cellular telephone, such that the change is effective immediately, particularly if done during banking hours at his branch office.

In all of the examples given, the instantaneous changing of features from one account to another is accomplished without the need to close an account and to open another account. The features can be changed, added or the account opened in any way that is available, including but not limited to at a bank branch, a bank kiosk office, via the Internet or though an Intranet (either system being accessible through personal computers of all kinds (having Internet access) PDAs, Cellular telephones and other communications means), through a telephone call center, using a specially programmed ATM and other means which are known to persons having ordinary skill in the art. Further, each of the features mentioned can be had simultaneously in an account for a fee for each feature over the initial two. It may be that the additional features, in spite of the bank fees, will prove to be beneficial and cost effective for the customer. It will be understood by persons having ordinary skill in the art that various changes and configurations of accounts can be made without departing from the novel scope of the present invention. Further, the account holder can open more than one account and use each account differently so that the features taken can accommodate different aspects of his lifestyle, also without departing from the novel scope of the present invention. Also, it will be understood that the examples given are for illustrative purposes and are not meant to be limiting; the number of combinations of features and uses is large and so would be difficult to relate in the present application; however, persons having ordinary skill in the art can derive all of the combinations of features allowable in the present embodiment and will understand that with the addition of more features, more combinations will be available, all without departing from the novel scope of the present invention.

It will be understood that major aspects of the account and method of the present invention are computer based and run on software and systems presently available and known to persons having ordinary skill in the art. In the preferred embodiment of the present invention banking and financial institutions can accomplish the variables of the account of the present invention using a number of readily available software and Internet tools and service providers used through purchase or subscription. For example the process of opening an account on-line can be accomplished using a third party to take applications online for new account opening (such parties as The CashEdge). The same process can also be done in house using banking software such as Corillian or software from S1 Corporation of Norcross, Ga., or FFI (which are software vendors that allow banking customers to access and update account information via the Internet) as well as Extract, Transform and Load (ETL) systems which accomplishes data loads and nightly processing. In a preferred embodiment, the ETL systems can load data from the core banking applications, which at Compass Bank reside on the mainframe, into the Custom Options Database (CCDB). The ETL also maps data from the CCDB to the core application. As an example of this mapping, any charges for additional options selected will be sent through the ETL mappings which will select records that require a charge in the Demand Deposit Account (DDA) system and format a transaction to export to the DDA system.

With respect to types of checking and savings accounts systems, in the present embodiment the bank would use Fidelity Banking Systems; however there are many vendor and in-house written systems that will process DDA and/or savings accounts. Fidelity Banking Systems further can be configured to process ATM and Check Card transactions as well as any options that provide free ATM fees, cash back bonuses, VISA® points, etc. can therefore be sent to this application. Fidelity Banking Systems can also be used to processes checks and debit and credit transactions to be sent on to other core apps (such as the DDA and Savings system, Loans system, etc.).

In a preferred embodiment the Internet Banking System can be used as a back-end application that can be further configured to send email acknowledgement notices to customers who change their options online. It will be understood by persons having ordinary skill in the art that the above noted software and computer systems are given as an example of software and systems that can be used to accomplish the goals of the present invention, but the listing is not meant to be limiting and that other software, systems and methods of performing the method and making an account of the present invention can be substituted or modified without departing from the novel scope of the present invention.

Although illustrative embodiments of the invention have been shown and described, it is to be understood that various modifications and substitutions may be made by those skilled in the art without departing from the novel spirit and scope of the invention.

What is claimed is:

1. An account for the management of money having easily interchangeable features, comprising:
computer program functions having means to receive and process banking information and change account information and features as directed;
a number of platforms from which to access the computer program;
a list of desirable banking instruments from which a customer may choose a select number, wherein, the account is openable with selected features and then, when desired, changeable by the selection of other features and/or the dropping of present features or a combination of both at the direction of the account holder through an access platform to the computer program.

2. The account for the management of money of claim 1, wherein the list of desirable features includes a first set of standard features and a second set of premium features, the account including all of the first set of standard features and at least two features from the second set of premium features.

3. The account for the management of money of claim 2, wherein the account includes 10 standard features and two premium features at no cost to the customer.

4. The account for the management of money of claim 2, wherein the premium features selected can be exchanged for those not selected, all in real time.

5. The account for the management of money of claim 3, wherein the account includes 10 standard feature and any number of premium features wherein any features over 12 features, standard and premium, are provided at a cost to the customer.

6. The account for the management of money of claim 1, wherein the platforms for access to the account include telephone centers, personal computer access via the Internet and bank branch access through banking personnel services and changes to the features of the account can be accomplished at each platform.

7. The account for the management of money of claim 1, wherein the desirable features include financial instruments offering point rewards for use.

8. The account for the management of money of claim 1, wherein the desirable features include financial instruments offering convenience for use.

9. The account for the management of money of claim 1, wherein the desirable features include financial instruments offering monetary rewards for use.

10. A computer implemented method of managing assets in a bank environment by providing a number of interchangeable account features, including the steps of:
providing a customer with a choice of a number of first banking or financial features;
providing the customer with a choice of a number of second banking or financial features;
allowing the customer to initially select several of the first banking or financial features and second banking or financial features as part of the account and then allowing for the selection of further features from either the first or second banking or financial features either as replacements for the initially selected features or at a cost as additional features; and,
monitoring and manipulating the interchangeable features via a computer running software associated therewith.

11. The method of claim 10, wherein the first set of banking or financial features are standard banking features typical of checking accounts.

12. The method of claim 11, wherein the second set of banking or financial features are premium banking features.

13. The method of claim 10, wherein the computer implemented method is accessible via the Internet.

14. The method of claim 10, wherein the computer implemented method is accessible via a call center over the telephone.

15. The method of claim 10, including the step of providing the first set of banking features at no cost to the customer.

16. The method of claim 10, including the step of providing two of the second set of banking features at no cost to the customer.

17. The method of claim 10, including the step of providing a set number of first and second banking features at no cost to the customer.

18. The method of claim 10, wherein the selection of further or additional features is done through computer processes that allow real time changes in the account.

19. A computer implemented method of managing assets in a bank environment by providing a number of interchangeable account features, including the steps of:
providing a customer with a choice of a number of first banking or financial features;
providing the customer with a choice of a number of second banking or financial features;
allowing the customer to initially select all of the first banking or financial features and two of the second banking or financial features as part of the account and then allowing for the selection of further features from either the first or second banking or financial features either as replacements for the initially selected features or at a cost as additional features;
providing a customer with real time changes in features; and,
monitoring and manipulating the interchangeable features via a computer running software associated therewith.
